(19) United States
(12) Patent Application Publication
(10) Pub. No.: US 2024/0060154 A1
(43) Pub. Date: Feb. 22, 2024

(54) METHOD FOR COLLECTING CALCIUM AND RARE EARTH METAL FROM SLAG

(71) Applicant: GWANGJU INSTITUTE OF SCIENCE AND TECHNOLOGY, Gwangju (KR)

(72) Inventors: Youngjune PARK, Gwangju (KR); Yechan PARK, Gwangju (KR); Gyudae SIM, Gwangju (KR)

(21) Appl. No.: 18/270,545

(22) PCT Filed: Nov. 26, 2021
(86) PCT No.: PCT/KR2021/017594

§ 371 Date: Jun. 30, 2023

(30) Foreign Application Priority Data
Jan. 15, 2021 (KR) 10-2021-0005995

(51) Int. Cl. C22B 59/00; C22B 1/00; C22B 7/00

(52) U.S. Cl. CPC C22B 59/00; C22B 1/005; C22B 7/007

(57) ABSTRACT

A method of recovering calcium and a rare earth metal from slag includes: a step (S100) for forming alkali silicate by performing alkali fusion on slag including silicon (Si), calcium (Ca), and a rare earth metal and reacting the silicon with an alkali metal salt; a step (S200) for removing the silicon and other impurities from the slag by leaching and separating the alkali silicate using distilled water; a step (S300) for leaching, into an acid solution, the calcium and the rare earth metal included in the slag from which the silicon and the other impurities are removed; and a step (S400) for recovering the calcium and the rare earth metal leached into the acid solution.

### TECHNICAL FIELD

The present invention relates to a method of recovering metal from slag, and more particularly, to a method of recovering calcium and a rare earth metal from slag.

### BACKGROUND ART

In addition to consuming a large amount of raw materials and energy to produce steel, the steel industry also generates a large amount of various types of by-products and wastes through a complex production process including raw materials, iron making, steelmaking, and rolling.

Slag, which accounts for the largest amount among the by-products, is inevitably produced from gangue components of iron ore or coke in an iron-making process, and by oxides produced during oxidation and deoxidation of molten iron or molten steel in a steel-making process, or by additives added for refining.

The amount of slag generated is rapidly increasing every year, and thus, various studies have been attempted to industrially recycle slag thus generated, and currently, slag is mainly recycled into building and civil engineering materials. However, since the amount of slag being recycled is not sufficient, a large amount of slag still needs to be disposed of at a cost. When slag is utilized as a building material, the slag may be used as slag cement using slag as a main material or a cement admixture obtained by pulverizing slag. As described above, when slag is used as a substitute for cement or as a cement admixture obtained through a pulverizing process, the slag is utilized as a high value-added product, but some of them are still utilized as a low price road filling material or the like.

Slag includes blast furnace slag, converter slag, and electric arc furnace slag are mostly consist of SiO₂ and CaO and may include Al₂O₃, FeO, MgO, P₂O₅, and CaS depending on the type of refining reaction.

Since such slag includes a large amount of useful metals/non-metals that are recyclable in an industrially meaningful way, there is a need to find a method to economically recycle slag.

In the related art, in a process for recovering useful metals within slag, when useful metals are leached into an acid, silicon, which is abundant in slag, forms a passivation layer which is deposited on the surface of the slag to block reaction between the leaching solvent and useful metals inside particles, and thus, there has been a limitation in efficiency of an acid leaching process.

### Prior Art Document

(Patent Document 1) KR 10-1953443

### DISCLOSURE

### Technical Problem

The technical object to be achieved by the present invention is to provide a method of recovering calcium and a rare earth metal from slag, which does not form a silicon passivation layer so as to improve a leaching rate of useful metals.

The technical object to be achieved by the present invention is not limited to the above-described technical object, and other technical objects that are not mentioned will be clearly understood by those of ordinary skilled in the art from the following description.

### Technical Solution

In order to achieve the technical object, an embodiment of the present invention provides a method of recovering calcium and a rare earth metal from slag.

In an embodiment of the present invention, a method of recovering calcium and a rare earth metal from slag includes: forming alkali silicate by performing alkali fusion on slag including silicon (Si), calcium (Ca), and a rare earth metal and reacting the silicon with an alkali metal salt; removing the silicon and other impurities from the slag by leaching and separating the alkali silicate using distilled water; leaching, into an acid solution, the calcium and the rare earth metal included in the slag from which the silicon and the other impurities are removed; and recovering the calcium and the rare earth metal leached in the acid solution.

In an embodiment of the present invention, the alkali fusion may include: mixing the alkali metal salt with the slag including the silicon (Si), the calcium (Ca), and the rare earth metal; and forming the alkali silicate by performing heat treatment such that the silicon and the alkali metal salt react.

In an embodiment of the present invention, the rare earth metal may include cerium (Ce) or scandium (Sc).

In an embodiment of the present invention, the alkali metal salt may include at least one selected from the group consisting of sodium hydroxide (NaOH), potassium hydroxide (KOH), sodium peroxide (Na₂O₂), sodium chloride (NaCl), and sodium carbonate (Na₂CO₃).

In an embodiment of the present invention, the slag and the alkali metal salt may be mixed in a weight ratio of 1:0.33 to 4.

In an embodiment of the present invention, the heat treatment may be performed at 300° C. to 1,000° C.

In an embodiment of the present invention, the alkali silicate may include sodium silicate or potassium silicate.

In an embodiment of the present invention, the alkali silicate is a crystalline water-soluble compound that may be dissociated in the distilled water and removed by solid-liquid separation.

In an embodiment of the present invention, the acid solution may include an inorganic acid or an organic acid.

In an embodiment of the present invention, the concentration of the acid solution may be 1 M to 5 M.

In an embodiment of the present invention, the leaching of the calcium and the rare earth metal into the acid solution may be performed at a temperature of 25° C. to 150° C. for 10 minutes to 20 hours.

### Advantageous Effects

According to an embodiment of the present invention, a crystal change of non-crystalline slag may be induced through alkali fusion, and crystalline slag may be formed, and thus, insoluble silicon within the slag is changed into a water-soluble silicon compound to remove silicon and other impurities in advance in a washing step, and acid leaching efficiency of calcium and a rare earth element is increased, and ultimately, collection efficiency of calcium and a rare earth element may be increased.

In addition, calcium within the slag is formed into calcium oxide (CaO) and portlandite (Ca(OH)₂) during the alkali fusion and the washing process, and thus, acid leaching may easily occur.

The effects of the present invention are not limited to the above-described effects, and it should be understood that the effects include all effects that can be inferred from the configuration of the invention described in the detailed description of the invention or the claims.

### DESCRIPTION OF DRAWINGS

FIG. 1 is a flowchart of a method of recovering calcium and a rare earth metal from slag, according to an embodiment of the present invention.

FIG. 2 is SEM images of (a) after performing alkali fusion on slag, (b) after washing using distilled water, and (c) after leaching into an acid solution, according to an embodiment of the present invention.

FIG. 3 is an XRD graph of leaching into distilled water and leaching into 3 M HCl after performing alkali fusion on slag at 600° C. for 1 hour, according to an embodiment of the present invention.

FIG. 4 is (a) a comparative graph of leaching rates of metal elements according to alkali fusion temperatures in a distilled water washing step and (b) a comparative graph of leaching rates of metal elements in 3M HCl according to fusion times at 600° C., according to an embodiment of the present invention.

### MODE FOR INVENTION

In the following description, the present invention is described with reference to the accompanying drawings. However, the present invention may be implemented in various forms, and thus, is not limited to embodiments described herein. In addition, irrelevant descriptions are omitted to clearly explain the present invention, and throughout the specification, the same or corresponding elements are indicated by the same reference numerals.

Throughout the specification, when a portion is connected (accessed, contacted, or coupled) with other portions, it includes direction connection as well as indirect connection in which the other member is positioned there between. Furthermore, throughout the specification, when a portion “includes” an element, another element may be further included, rather than excluding the existence of the other element, unless otherwise described.

The terms used in the present specification are merely used to describe particular embodiments, and are not intended to limit the inventive concept. The expression of singularity in the specification includes the expression of plurality unless clearly specified otherwise in context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A method of recovering calcium and a rare earth metal from slag according to an embodiment of the present invention is described.

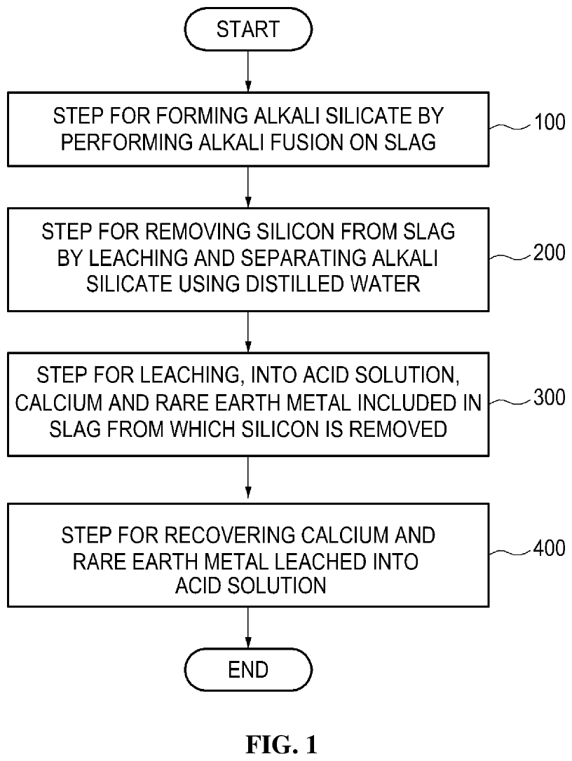

FIG. 1 is a flowchart of a method of recovering calcium and a rare earth metal from slag, according to an embodiment of the present invention.

Referring to FIG. 1, a method of recovering calcium and a rare earth metal from slag includes: a step (S100) for forming alkali silicate by performing alkali fusion on slag including silicon (Si), calcium (Ca), and a rare earth metal and reacting the silicon with an alkali metal salt; a step (S200) for removing the silicon and other impurities from the slag by leaching and separating the alkali silicate using distilled water; a step (S300) for leaching, into an acid solution, the calcium and the rare earth metal included in the slag from which the silicon and the other impurities are removed; and a step (S400) for recovering the calcium and the rare earth metal leached into the acid solution.

In the first step, alkali silicate is formed by performing alkali fusion on slag including silicon (Si), calcium (Ca), and a rare earth metal and reacting the silicon with an alkali metal salt (S100).

The slag may include all slag generated in steelworks, and may include, for example, blast furnace slag, steelmaking slag, and electric arc furnace slag.

Slag is a product that is inevitably generated by iron or steel smelting process, and is based on SiO₂ and CaO and includes Al₂O₃, FeO, MgO, P₂O₅, and CaS depending on the type of refining reaction.

The slag may be pulverized to have fine particles to improve reactivity.

The alkali fusion may refer to a process for roasting the feedstock with solid alkali flux aiming to transform the insoluble structure to be soluble phases.

For example, the alkali fusion may include: mixing the alkali metal salt with the slag including the silicon (Si), the calcium (Ca), and the rare earth metal; and forming the alkali silicate by performing heat treatment such that the silicon and the alkali metal salt react.

First, the alkali metal salt is mixed with the slag including the silicon (Si), the calcium (Ca), and the rare earth metal.

The rare earth metal may include cerium (Ce) or scandium (Sc).

The rare earth metal may be a material to be collected in the final step together with the calcium (Ca).

The alkali metal salt may refer to a hydroxide, a peroxide, a carbonate, a sulfate, a nitrate, a phosphate, or the like, which includes an alkali metal to react with the silicon in the alkali fusion.

For example, the alkali metal salt may include at least one selected from the group consisting of sodium hydroxide (NaOH), potassium hydroxide (KOH), sodium peroxide (Na₂O₂), sodium chloride (NaCl), and sodium carbonate (Na₂CO₃).

The alkali metal salt may react with the silicon through heat treatment performed in a subsequent step to change amorphous silicon included in the slag into alkali silicate which is crystalline silicon.

The slag and the alkali metal salt may be mixed in a weight ratio of 1:0.33 to 4.

When a weight ratio of the slag and the alkali metal salt is less than 0.33, the reaction with the silicon may not be sufficient, and when a weight ratio of the slag and the alkali metal salt is greater than 4, an excess of alkali metal salts may increase costs.

Next, alkali silicate may be formed by performing heat treatment such that the silicon and the alkali metal salt react.

The heat treatment may be performed at 300° C. to 1,000° C.

When the temperature of the heat treatment is less than 300° C., the alkali metal salt may not be fused, and when the temperature of the heat treatment is greater than 1,000° C., alkali metal elements may evaporate, and thus, proper alkali fusion with the slag may not occur.

In other words, the lower limit of the temperature of the heat treatment needs to be greater than the melting point of the alkali metal salt used, and needs to be greater than or equal to the melting point of the alkali metal salt by a certain amount in consideration of hysteresis during heating.

For example, when the alkali metal salt is sodium hydroxide (NaOH), the melting point of the sodium hydroxide (NaOH) is about 326° C., and thus, the heat treatment needs to be performed at a temperature of at least 326° C., and preferably, needs to be performed at about at least 400° C. in consideration of hysteresis.

In addition, the time for the heat treatment may be, for example, 10 minutes to 10 hours.

The time for the heat treatment needs to be greater than or equal to a time for sufficient reaction between the silicon within the slag and the alkali metal salt, and may vary depending on the type of the alkali metal salt or the like. Furthermore, a crystal structure produced after the alkali fusion varies depending on the time for the heat treatment, and accordingly, differences in silicon separation degree and acid leaching efficiency may occur, and thus, the time for the heat treatment may be adjusted appropriately to target conditions.

For example, an alkali fusion process may be performed by heating a mixture of the slag and the sodium hydroxide (NaOH) in a weight ratio of 1:1 in a furnace at 600° C. for 4 hours.

Through the alkali fusion, amorphous silicon included in the slag reacts with an alkali material to cause a change in crystal structure, such that alkali silicate which is crystalline silicon may be formed.

The alkali silicate may include sodium silicate or potassium silicate.

In addition, the alkali silicate may further include other metals such as A1, in addition to Na or K.

For example, the alkali silicate may include sodium aluminum silicate.

The alkali silicate is crystalline and has water-soluble properties. Accordingly, the alkali silicate may be dissolved in distilled water and separated in a subsequent step.

In addition, the calcium included in the slag is formed into calcium oxide (CaO) by the alkali fusion, and the calcium oxide (CaO) reacts with distilled water in a subsequent step to be formed into calcium hydroxide (Ca(OH)₂) so as to be easily leached into an acid material.

Accordingly, the alkali silicate is dissolved in the distilled water in a subsequent washing step, the calcium oxide (CaO) and the calcium hydroxide (Ca(OH)₂) are dissolved in a subsequent acid leaching step such that calcium leaching efficiency is increased, and in the above series of processes, rare earth metals freed from amorphous silicon are further arranged on the surface of the slag, and finally, collection efficiency of the calcium and rare earth elements may be increased.

In the second step, the silicon and other impurities are removed from the slag by leaching and separating the alkali silicate using distilled water (S200).

The slag subjected to the alkali fusion includes crystalline alkali silicate, and since the alkali silicate is water-soluble, the alkali silicate may be easily extracted (dissociated) using distilled water.

The alkali silicate extracted using the distilled water may be removed by solid-liquid separation.

The separation process may be performed by passing the alkali silicate through a filter having a 0.3-0.5 μm pore using a pressure pump or by centrifugation, but is not limited thereto.

In addition, the other impurities may include, for example, an alkali metal or aluminum, and may include materials other than the calcium and the rare earth metal to be finally collected.

The other impurities may also be leached into distilled water and removed by solid-liquid separation together with the alkali silicate.

Since a conversion of the silicon within the slag into the alkali silicate varies depending on the temperature of the alkali fusion or the like, the extent to which the silicon within the slag is removed by washing the alkali silicate using distilled water may be all or part of the silicon within the slag.

For example, a proportion of the silicon within the slag to be removed may be about 5 wt % to about 40 wt % of the silicon based on 100 wt % of the total silicon within the slag.

In a conventional process for leaching a metal from slag, since silicon is not removed from the slag, a silicon passivation layer is formed, and thus, there has been a limitation in leaching efficiency when useful metals are extracted in a subsequent acid leaching step, but as with the present invention, when silicon is partially removed in advance, leaching efficiency may significantly increase.

For example, in a case where the silicon within the slag is removed by about 7 wt %, when acid leaching using HCl is performed, acid leaching efficiency of the calcium may be increased by about 30%, and acid leaching efficiency of the cerium (Ce) may be increased by about 60%.

In the third step, the calcium and the rare earth metal included in the slag from which the silicon and the other impurities are removed are leached into an acid solution (S300).

A leaching process may be performed on the slag from which all or part of the silicon is removed in the acid solution, and the calcium and the rare earth metal within the slag may be easily leached into the acid solution as all or part of the silicon is removed in a previous washing step.

In particular, the calcium is formed into calcium oxide (CaO) through the alkali fusion and formed into portlandite (Ca(OH)₂) through a distilled water washing process, and thus, may be leached with a very high reactivity in an acid leaching process.

The acid solution may include an inorganic acid or an organic acid.

For example, the inorganic acid may include hydrochloric acid (HCl), nitric acid (HNO₃), sulfuric acid (H₂SO₄), or hydrofluoric acid (HF).

For example, the organic acid may include carboxylic acid (RCOOH), sulfinic acid (RSO₂H), or sulfonic acid (RSO₃H).

The concentration of the acid solution may be 1 M to 5 M.

When the concentration of the acid solution is less than 1 M, the calcium and the rare earth metal may not be sufficiently leached, and when the concentration of the acid solution is greater than 5 M, cost of chemical materials may be high, and very strong acid may cause collapse of a silicon structure remaining within the slag, resulting in gelation of the entire material through a polymerization process of the collapsed silica structure after or during the reaction, and even during solid-liquid separation, due to the strong viscosity of silicon, cost and time for the solid-liquid separation may be excessively consumed, or solid-liquid separation may be impossible.

The leaching of the calcium and the rare earth metal into the acid solution may be performed at a temperature of 25° C. to 150° C. for 10 minutes to 20 hours.

When the temperature of the leaching is less than 25° C., the leaching may not be smooth, and when the temperature of the leaching is greater than 150° C., there may be a problem of excessive leaching of impurities other than the calcium and the rare earth metal.

The time for the leaching into the acid solution may be, for example, 10 minutes to 20 hours, and may be adjusted in consideration of the amount and collection efficiency of the calcium and the rare earth metal.

In the fourth step, the calcium and the rare earth metal leached into the acid solution are collected (S400).

For example, the calcium leached into the acid solution may be collected using a carbonation process in which the calcium reacts with carbon dioxide (CO₂) so as to be precipitated in the form of CaCO₃.

In addition, the rare earth metal leached into the acid solution may be precipitated in an oxidized form by adjusting the pH to 6 to 8 by adding a strong alkali such as NaOH, KOH, or NH₄OH, or may be precipitated in the form of a coordinate compound by adding a ligand such as oxalate, and may be concentrated to 1 wt % to 4 wt % and collected as ore.

In addition, the recovering of the calcium and the rare earth metal may be performed by a known method.

### Example

First, after slag including silicon (Si), calcium (Ca), and cerium (Ce) was mixed with sodium hydroxide (NaOH) in a weight ratio of 1:1, alkali fusion was performed at 600° C. for 4 hours, and thus, sodium silicate was formed. Next, the sodium silicate was removed by leaching into distilled water. Next, the calcium (Ca) and the cerium (Ce) within the slag from which the sodium silicate was removed was leached using 3 M HCl. The calcium (Ca) and the cerium (Ce) leached into the hydrochloric acid (HCl) were collected by carbonation, oxidation, and concentration in the form of a coordinate compound.

### Experimental Example

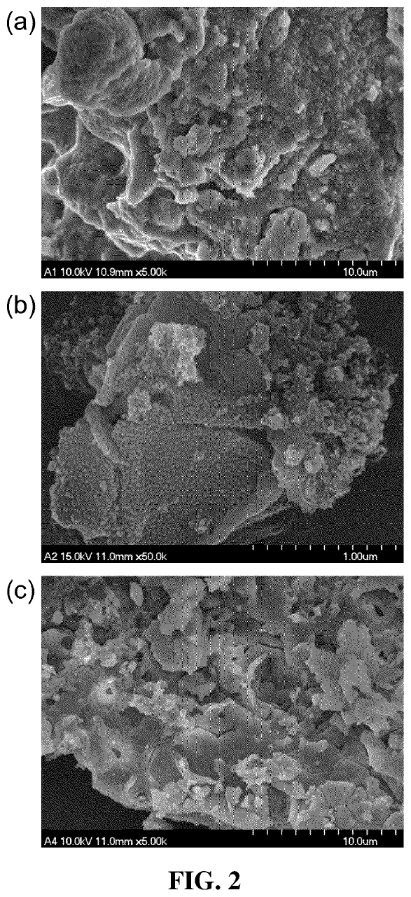

FIG. 2 is SEM images of (a) after performing alkali fusion on slag, (b) after washing using distilled water, and (c) after leaching into an acid solution, according to an embodiment of the present invention.

Referring to FIG. 2, the SEM images of after performing the alkali fusion, after washing using the distilled water, and after leaching into the acid solution may be confirmed. Since (a) a surface shape after performing the alkali fusion and (b) the surface shape of the slag after washing using the distilled water are significantly different, it could be confirmed that water-soluble alkali silicate was removed after the alkali fusion.

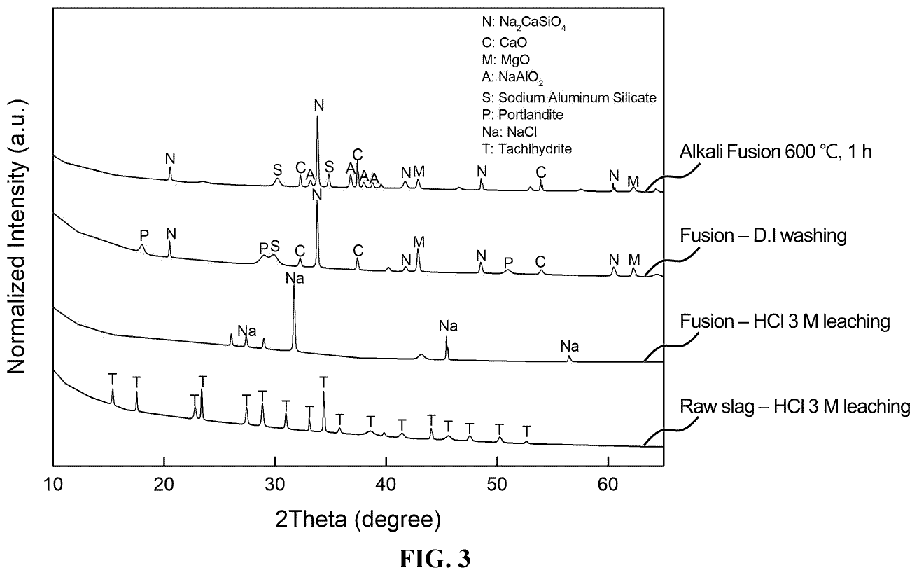

FIG. 3 is an XRD graph of leaching into distilled water and leaching into 3 M HCl after performing alkali fusion on slag at 600° C. for 1 hour, according to an embodiment of the present invention.

Referring to FIG. 3, first, after the alkali fusion (blue), the presence of sodium silicate and calcium oxide could be confirmed. Next, after washing (red), it could be confirmed that sodium aluminum silicate and NaAlO₂ were removed. Next, after acid leaching (green), it could be confirmed that a calcium-containing material was leached.

In contrast, in the case of acid leaching of slag on which alkali fusion was not performed, it could be confirmed that non-crystalline blast furnace slag formed tachyhydrite (T) which is a compound of Ca, Mg, and Cl.

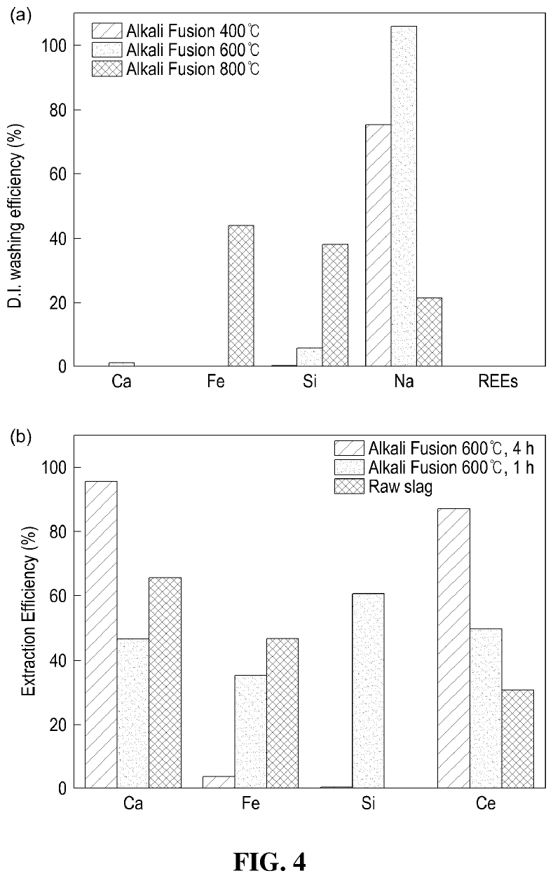

FIG. 4 is (a) a comparative graph of leaching rates of metal elements according to alkali fusion temperatures in a distilled water washing step and (b) a comparative graph of leaching rates of metal elements in 3M HCl according to fusion times at 600° C., according to an embodiment of the present invention.

Referring to FIG. 4, (a) it could be confirmed that removal of Si was insignificant at 400° C. (the lowest bar of Si), Si was removed by 7-10 wt % at 600° C. (the middle bar of Si), and Si was removed by about 40 wt % at 800° C. (the highest bar of Si). (b) It could be confirmed that when an alkali fusion temperature of 600° C., which was a relaxed condition in which silicate was removed to some extent, was selected and compared in terms of acid leaching rate with slag on which alkali fusion was not performed, the leaching rate of calcium (Ca) was increased by about 30%, and the leaching rate of cerium (Ce) was increased by about 60%.

According to an embodiment of the present invention, a crystal change of non-crystalline slag may be induced through alkali fusion, and crystalline slag may be formed, and thus, insoluble silicon within the slag is changed into a water-soluble silicon compound to remove silicon and other impurities in advance in a washing step, and acid leaching efficiency of calcium and a rare earth element is increased, and ultimately, collection efficiency of calcium and a rare earth element may be increased.

In addition, calcium within the slag is formed into calcium oxide (CaO) and portlandite (Ca(OH)₂) during the alkali fusion and the washing process, and thus, acid leaching may easily occur.

The above description of the present invention is for illustration, and those of ordinary skill in the art to which the present invention pertains can understand that it can be easily modified into other specific forms without changing the technical spirit or essential features of the present invention. Therefore, it should be understood that the embodiments described above are illustrative in all respects and not restrictive. For example, each element described as a single type may be implemented in a distributed form, and likewise elements described as distributed may be implemented in a combined form.

The scope of the present invention is indicated by the following claims, and all changes or modifications derived from the meaning and scope of the claims and their equivalents should be construed as being included in the scope of the present invention.

1. A method of recovering calcium and a rare earth metal from slag, the method comprising:
forming alkali silicate by performing alkali fusion on slag comprising silicon (Si), calcium (Ca), and a rare earth metal and reacting the silicon with an alkali metal salt;
removing the silicon and other impurities from the slag by leaching and separating the alkali silicate using distilled water;
leaching, into an acid solution, the calcium and the rare earth metal included in the slag from which the silicon and the other impurities are removed; and
recovering the calcium and the rare earth metal leached into the acid solution.

2. The method of claim 1, wherein, in the forming of the alkali silicate, the alkali fusion comprises:
mixing the alkali metal salt with the slag including the silicon (Si), the calcium (Ca), and the rare earth metal; and
forming the alkali silicate by performing heat treatment such that the silicon and the alkali metal salt react.

3. The method of claim 2, wherein, in the mixing of the alkali metal salt with the slag, the rare earth metal comprises cerium (Ce) or scandium (Sc).

4. The method of claim 2, wherein, in the mixing of the alkali metal salt with the slag, the alkali metal salt comprises at least one selected from the group consisting of sodium hydroxide (NaOH), potassium hydroxide (KOH), sodium peroxide (Na₂O₋₂), sodium chloride (NaCl), and sodium carbonate (Na₂CO₃).

5. The method of claim 2, wherein, in the mixing of the alkali metal salt with the slag, the slag and the alkali metal salt are mixed in a weight ratio of 1:0.33 to 4.

6. The method of claim 2, wherein, in the forming of the alkali silicate, the heat treatment is performed at 300° C. to 1,000° C.

7. The method of claim 2, wherein, in the forming of the alkali silicate, the alkali silicate comprises sodium silicate or potassium silicate.

8. The method of claim 1, wherein, in the removing of the silicon from the slag, the alkali silicate is a crystalline water-soluble compound that is dissociated in the distilled water and removed by solid-liquid separation.

9. The method of claim 1, wherein, in the leaching of the calcium and the rare earth metal into the acid solution, the acid solution comprises an inorganic acid or an organic acid.

10. The method of claim 9, wherein a concentration of the acid solution is 1 M to 5 M.

11. The method of claim 1, wherein the leaching of the calcium and the rare earth metal into the acid solution is performed at a temperature of 25° C. to 150° C. for 10 minutes to 20 hours.
